(19) United States
(12) Patent Application Publication
(10) Pub. No.: US 2002/0109687 A1
(43) Pub. Date: Aug. 15, 2002

(54) Visibility and usability of displayed images

(75) Inventors: Keita Ishii, Yokohama-shi (JP); Kenichi Kurumiya, Sagamihara-shi (JP); Arimasa Naitoh, Fujisawa-shi (JP); Yasumasa Takeda, Sagamihara-shi (JP)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/021,911

(22) Filed: Dec. 13, 2001

(30) Foreign Application Priority Data
Dec. 27, 2000 (JP) 2000-397045

(51) Int. Cl. G09G 5/26

(52) U.S. Cl. 345/472.2; 345/611; 345/671

(57) ABSTRACT

A computer system, display device, display controller, and image processing method are described which provide high visibility and usability. A portion of an image displayed on a display screen of the display device is enlarged in one direction and the enlarged image is displayed in a window. In one example, a portion of the image displayed in the display is enlarged in the vertical direction when the text runs along a horizontal direction.

### BACKGROUND OF THE INVENTION

The present invention relates to a computer system, display device, display controller, and image processing method that are suitable for use in displaying images.

Display devices with a Liquid Crystal Display (LCD) panel or Cathode Ray Tube (CRT) are widely used for personal computers and other apparatus. The resolution of the display device has been increased dramatically by the recent technological advances. This allows the entirety of a large image (consisting of a large number of dots) to be displayed on a display area in the display device or a large number of objects to be displayed at a time on the display screen.

On the other hand, the smaller a dot pitch (or the larger the number of dots in a unit area), the smaller characters and icons displayed on the display screen, their visibility. This imposes strain on the eyes of a user and causes a serious problem for weak-sighted users.

Conventionally, the size of an object disposed on a desktop can be changed by changing the resolution of the desktop on the display screen according to the user's preference.

However, when the resolution of the desktop is decreased to display an enlarged character or other objects, the entire area of the desktop cannot be displayed on the display area of the display, or a plurality of objects cannot be displayed on the display at a time. In some types of operating system, the user may experience discontinuity in sense of use because at least rebooting of a display or display driver is performed by the operating system when the resolution of the desktop is changed. Therefore, changing the resolution of the desktop is not a fundamental solution to the problem.

A character can be enlarged by using a larger font. However, this enlarges all characters on a screen, reducing the amount of information displayable on the entire screen and therefore diminishing the benefit of a display at higher resolution.

To solve these problems, computers have emerged recently that have a tool for zooming a portion of a display screen as shown in FIGS. 8 and 9.

The tool shown in FIG. 8 enlarges an area, A, with respect to the position of the mouse pointer (pointer), P, to display the content of the area in a zoom window, W1, displayed at the top of the display area.

The tool shown in FIG. 9 enlarges an area, B, with respect to the position of the mouse pointer (pointer), P, in FIG. 9A, which shows a state before the enlargement, to display the content of the area in a zoom window W2 displayed over area B as shown in FIG. 9B.

When using these tools, the user moves mouse pointer P into a potion that the user wants to enlarge, then performs a predetermined operation. Then zoom window W1 or W2 pops up on the display screen and characters within the area are enlarged both in the vertical and horizontal directions by a predetermined factor.

The approaches shown in FIGS. 8 and 9, however, have the following problems.

Both of the approaches take out an image in a portion of the display area to enlarge the image vertically and horizontally and display it in zoom window W1, W2. Therefore characters on an entire line displayed on the original display area do not fit into zoom window W2, the width of which is smaller than that of the display area, nor even in zoom window W1 having substantially the same width that of the display area.

Therefore, to read the sentence until the end of the line, the user must move mouse pointer P horizontally to scroll through area A or B displayed in zoom window W1 or W2. Because the user must manipulate the mouse in the middle of the line while reading the text, he/she cannot concentrate on reading and may feel cumbersome. In addition, if the moving direction of mouse pointer P is skewed while moving horizontally, a line above or below an intended line may be displayed in zoom window W1, W2.

The present invention has been made in view of these technical problems and it is a purpose of the present invention to provide a computer system, display device, display controller, and image processing method that provide high visibility and usability.

### SUMMARY of the INVENTION

To attain the purpose, a computer system according to the present invention is characterized by enlarging means enlarging an image within a portion of a screen displayed on a display in the vertical or horizontal direction of the screen when a predetermined event is caused by a user's operation. This enlarges characters and marks displayed in that display portion. Preferably, a direction orthogonal to the direction in which character strings run is chosen as the direction of enlargement of the image. The enlargement is accomplished solely by enlarging the image. Therefore the direction of the enlargement is not set by recognizing the direction in which character strings in the image run. Instead, the direction should be set in advance.

The vertical or horizontal direction of the screen matches a direction in which character strings run when the character strings (text) are vertically or horizontally displayed. In other words, the directions correspond to the two coordinate axes used for controlling the display device.

The portion to be enlarged may be set across or from the top to the bottom of the display area of the display device. The outline of a character can be smoothed by applying anti-aliasing to an image when enlarged.

The enlarged image may be superposed on its original area in order to reduce the travel distance of user's eyes, or may be displayed in another position.

The computer system may be a personal computer (PC) or other device, such as a mobile phone terminal, Personal Digital Assistants (PDA), or car navigation system; in short any system that displays text on a display device.

The present invention may be considered as a display device itself such as a monitor that has a display controller for vertically or horizontally enlarging an image displayed in a portion of the display area of the display device.

In the display controller, data concerning the image to be displayed on a portion of the display area is retrieved by a data retrieval section and the retrieved image is enlarged by an enlargement section.

The present invention may also be considered as an output device for outputting an image as a print out or in other forms. The output device is characterized in that it enlarges a portion of a first image vertically or horizontally to generate a second image, then outputs a third image obtained based on the second image.

The first image herein is an image before enlargement and generated based on data transferred from an external source. The second image is an enlarged portion of the first image. The third image is an image obtained by incorporating the second image into a portion of the first image or by disposing the second image and the first image side by side. The third image may be an image obtained by placing the second image on the first image.

The present invention may also be considered as a display controller for controlling what is displayed on a display device. The display controller obtains an image within an area set based on the position of the pointer identified by an pointer position identification circuit, and then enlarges the image vertically or horizontally, and then controls what is displayed on the display unit. The display controller may be a video driver for PC, a video game machine using a television set as a display device, or a set-top box.

The image within the area may be obtained as such data as bitmapped data, for example, and enlarged based on that data, thereby allowing the display controller to perform the enlargement process by itself without having to communicate with an application program.

To restore the enlarged image to its original image, the data concerning the image obtained is stored in an image storage circuit during the enlargement and the image enlarged by enlargement device is replaced with the image stored in the image storage circuit and is displayed on the display device.

The present invention may also be considered as a computer program for making a computer perform the vertical or horizontal enlargement of characters within an area established in a portion of a display area and display enlarged characters. The computer program may be provided as an enlargement program alone, may be incorporated into an operating system (OS) for a PC or an application program such as a word processor or browser, or may be a plug-in program of such an application program.

In particular, if the program is part or a plug-in program of an application program, characters may be enlarged in one direction by changing the font for the characters within the area. In such a case, the area may be set within an application window generated according to the application program.

### BRIEF DESCRIPTION OF THE DRAWINGS

Some of the purposes of the invention having been stated, others will appear as the description proceeds, when taken in connection with the accompanying drawings, in which:

FIG. 1 shows a configuration of a computer system according to the invention;

FIG. 2 shows an example of a screen display before enlargement;

FIG. 3 shows a flow of the screen enlargement process;

FIG. 4 shows an example of the screen display, a portion of which is enlarged by the process shown in FIG. 3;

FIG. 5 shows an example of an enlarged display in the Japanese language;

FIG. 6 shows an example of an enlarged display in a vertical scenario;

FIG. 7 shows the flow of a process for shifting a portion to be enlarged;

FIG. 8 shows one example of the image enlargement method according to current known methods; and

FIG. 9 shows another example of the image enlargement method according to currently known methods.

### DETAILED DESCRIPTION OF INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

Referring now more particularly to the accompanying drawings, a personal computer (PC) is used as an example of the computer system and a display device for the PC is used as an example of the display device/output device.

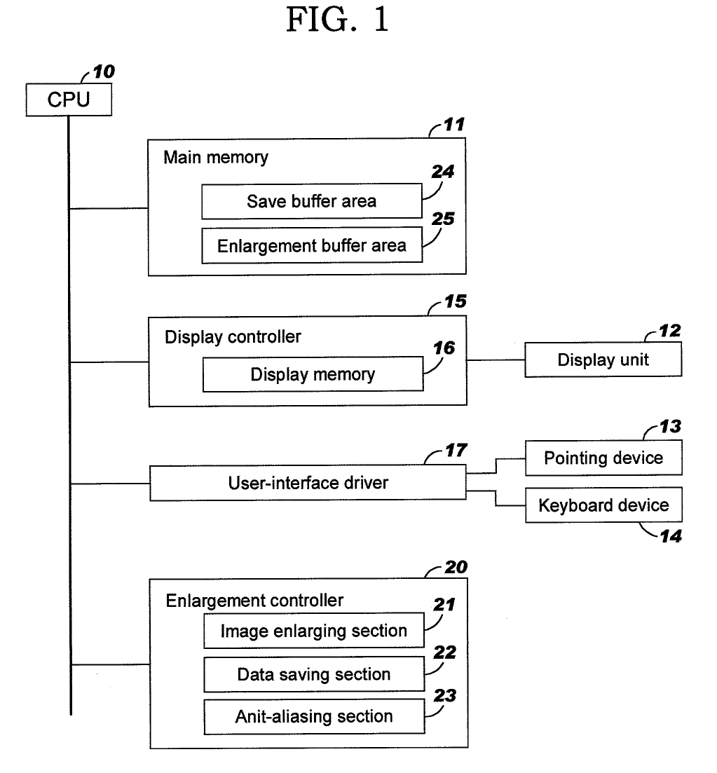

FIG. 1 shows a general configuration of the PC (computer system) according to the present embodiment. In FIG. 1, reference number 10 indicates a Central Processing Unit (CPU) which is responsible for the operation of the entire PC and is under the control of an Operating System (OS). Reference number 11 indicates main memory. Reference number 12 indicates a Liquid Crystal Display (LCD) panel or Cathode Ray Tube (CRT) display unit (display means, display device main unit, output device main unit). Reference number 13 indicates a pointing device such as a mouse for manipulating a mouse pointer (pointer) displayed on the display screen of the display unit 12, and reference number 14 indicates a keyboard device having arrow keys for manipulating the mouse pointer.

The PC includes a display controller (display controlling means, display controlling section) 15 for controlling a screen displayed on the display unit 12 according to a draw instruction from the CPU 10. The display controller 15 includes display memory 16 for storing image data transferred from the main memory 1 1 or other sources. The display unit 12 displays an image based on image data read from the display memory 16.

The pointing device 13 and keyboard device 14 has user-interface drivers (event generation means, pointer position identification means) 17 for processing events generated by a user manipulating these devices.

The PC also includes an enlargement controller (enlarging means, output controller) 20 for enlarging a portion of the display screen of the display unit 12.

The enlargement controller 20 includes an image enlarging section (enlarging section, area setting means) 21 for performing the enlargement of an image according to a program stored in the PC to generate an enlarged image and a data saving section (data retrieval section, image obtaining means, image restore means) 22 for saving original data when the image is enlarged, and an anti-aliasing section (anti-aliasing means) 23 for anti-aliasing a character during enlarging the image.

Accordingly a save buffer area (image storage means) 24 for temporarily storing data concerning the original image during enlargement processing in the image enlargement section 21 and a enlargement buffer area 25 for storing the enlarged image to be displayed on the display unit 12 are provided in the main memory 11.

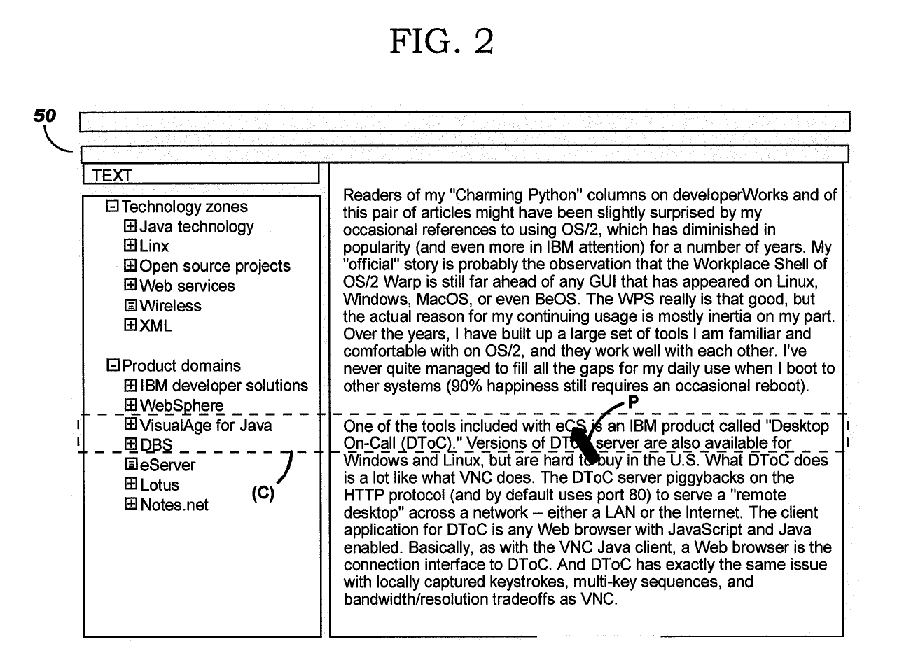

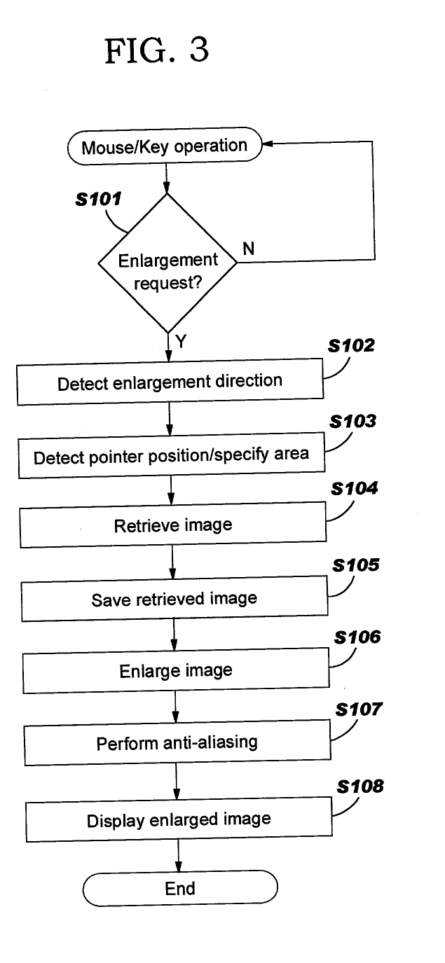

An example of enlarging a portion of the display screen in the PC configured as described above will be described below. FIG. 2 shows one example of the 20 display screen without enlargement. FIG. 3 shows a flow of a process for enlarging a portion of the display screen, which will be described below. As shown in FIG. 2, when an operation for enlargement by using the pointing device 13 or keyboard device 14 shown in FIG. 1 while an application window 50 is displayed over the entire display area of the display unit 12, the user-interface driver 17 detects the event and outputs a command for requesting the enlargement.

The enlargement controller 20 constantly monitors an enlargement request command output from the user-interface driver 17 (step S101). When the command is detected, the process proceeds to step S102 and the subsequent steps.

At step S102, it is determined whether the enlargement direction setting is vertical or horizontal. At step S103 and the subsequent steps, enlargement in the direction detected at step S102 will be performed. A prompt for the selection of the enlargement direction may be provided to a user each time the user performs an enlargement operation, or enlargement in the vertical direction may be set as the default and if the user desires enlargement in the horizontal direction, the user may override the default.

In the following description of step S103 and the subsequent steps, enlargement in the vertical direction will be described by way of example. At step S103, because the position of mouse pointer P on the display screen at the time when the operation requesting for the enlargement has been performed with the pointing device 13 or the keyboard device 14 is identified by the user-interface driver 17, the enlargement controller 20 is informed of the coordinates of the position of the mouse pointer P by the user-interface driver 17. The enlargement controller then sets an area, C, to be enlarged based on the coordinates of the position of mouse pointer P.

For enlargement in the vertical direction, the height of area C to be enlarged may be specified by the user or the default height may be taken, and the width of area C is set across the full width of the width of the display area of the display unit 12, that is, the full width of the application window 50.

Then the data saving section 22 in the enlargement controller 20 saves the image within the set area (C). Because data concerning the image displayed on the display unit 12 at this point is stored in the display memory 16 of the display controller 15, the data saving section 22 retrieves the image data within area C from the display memory 16 (step S1 04) and stores it in the save buffer area 24 provided in the main memory 11 (step S105).

Then the image enlarging section 21 in the enlargement controller 20 reads the data concerning the image within area C stored in the save buffer area 24 and performs image processing for enlarging the image in the vertical direction by a predetermined scale factor (step S106). Any scale factor may be set as the default value or specified by the user. This enlargement generates an enlarged image (second image).

The enlargement controller 20 applies anti-aliasing to the enlarged image to smooth the outline of characters and other objects in the image (step S107). This anti-aliasing (step S107) is not essential and is preferably applied depending on the need of the user or text to be enlarged.

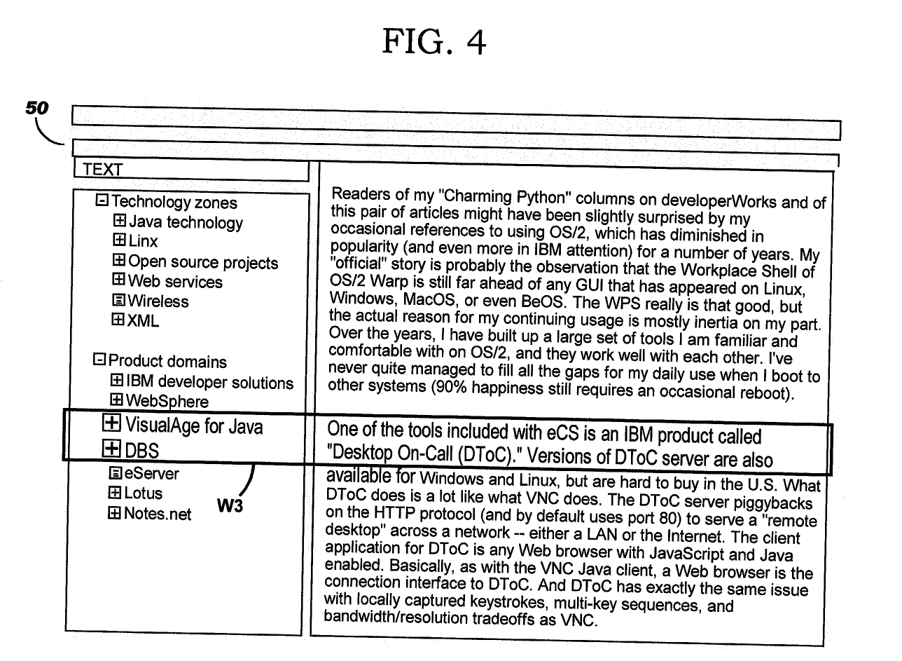

The data concerning the enlarged image processed at steps S106 and S107 is temporarily stored in the enlargement buffer area 25 of the main memory 11 . Then the data concerning the enlarged image is retrieved from the enlargement buffer area 25 and stored in the display memory 16 of the display controller 15. The display controller, which receives the data, displays the enlarged image according to the data stored in the display memory 16 (step S108). Here, window W3 is placed over area C (see FIG. 2) on the application window 50 with respect to the coordinates of the position of the mouse pointer P (known at step S103) as shown in FIG. 4 and the image within area C which is enlarged in the vertical direction is displayed in window W3. Thus, an image (third image) in which the enlarged image (second image) is placed over the image (first image) before enlarged (shown in FIG. 2) is displayed on the display unit 12.

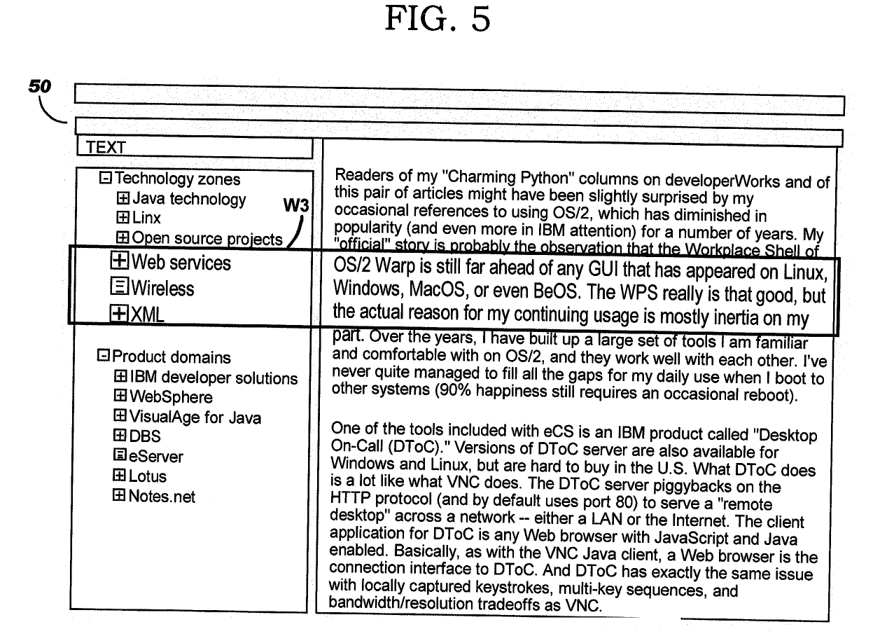

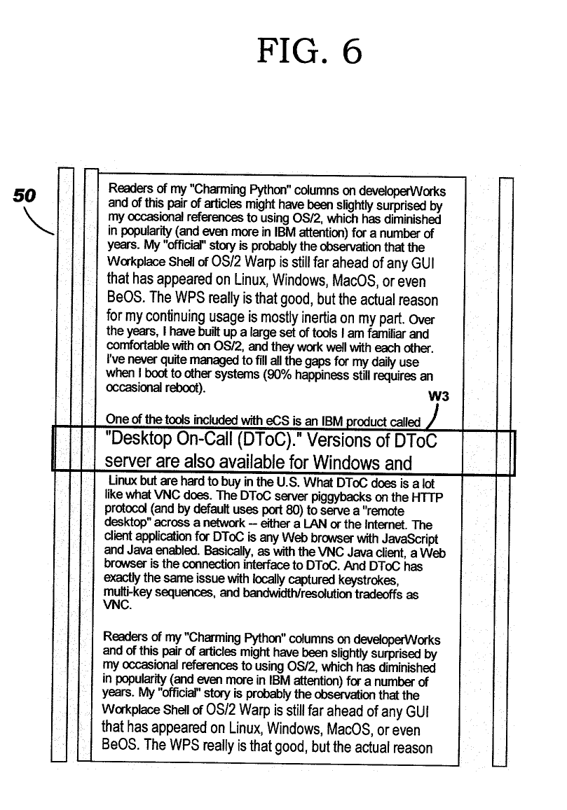

FIG. 5 shows an example in which Japanese text is enlarged in window W3 on the display screen by performing a process similar to the above-described process and FIG. 6 shows an example in which Japanese text is enlarged in the horizontal direction in Window W3′ by a process similar to the above-described process on a display screen on which Japanese text is displayed in vertical writing.

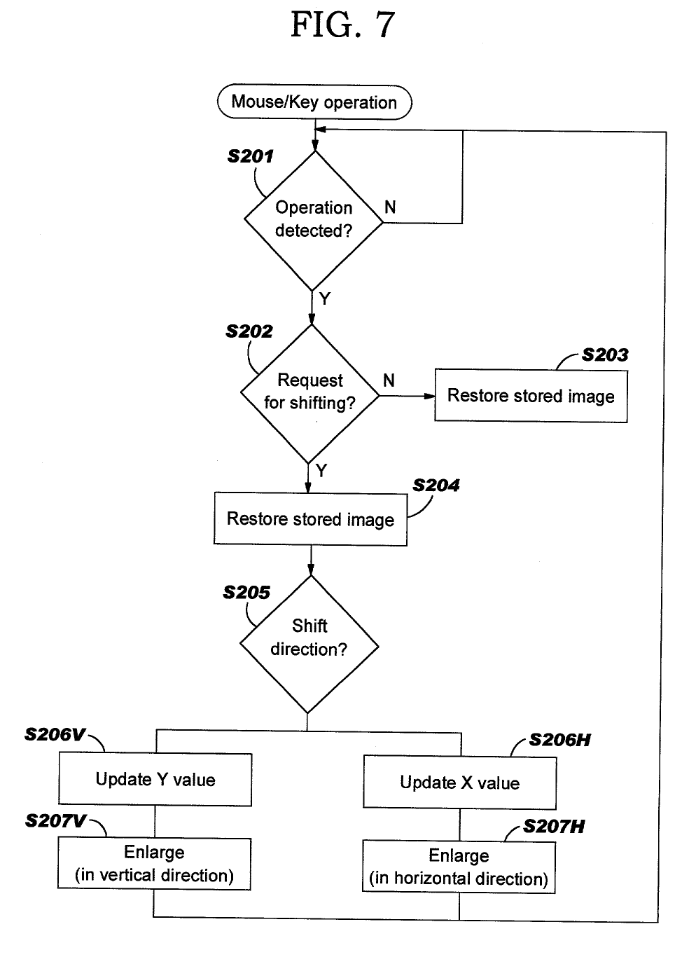

Once the enlarged image (characters) is displayed in the window W3 in this way, the enlargement controller 20 constantly monitors a command output from the user-interface driver 17, as shown in FIG. 7. This detects an operation with the pointing device 13 or keyboard device 14 performed in order to shift area C to be displayed in window W3 or to terminate enlargement in window W3 (step S201). The operation for shifting area C displayed in window W3 with the pointing device 13 or keyboard device 14 may be performed by manipulating pointing device 13 to move mouse pointer P or depressing an arrow key of the keyboard device 14.

When it is detected that a command generated in response to the operation of the pointing device 13 or keyboard device 14 is output from the user-interface driver 17, the process proceeds to step S202. Then it is determined whether the command output from the user-interface driver 17 is a request for shifting the display area (step S202). If it is not a shift request, the data saving section 22 reads the image data stored in the save buffer area 24 of the main memory 11 and transfers it to the display memory 16 to restore the image displayed on the display unit 12 to the state before being enlarged (the state shown in FIG. 2) (step S203).

If it is determined that the command output from the user-interface driver 17 at step S202 is a request for shifting the display area, the data saving section 22 reads the image data stored in the save buffer area 24 of the main memory 11 and transfers it to the display memory 16 to temporarily restore the image displayed on the display unit 12 to the state before being enlarged (the state shown in FIG. 2) (step S204).

Then it is determined whether the command output from the user-interface driver 17 is to shift the display area upward, downward, to the left, or to the right (step S205).

If the enlargement here is in the vertical direction (see FIG. 4), value Y (along vertical axis) of the coordinates (X, Y) of the reference position of area C to be enlarged is changed in the positive (+) or negative (−) direction with respect to the position of the mouse pointer P moved by the pointing device 13 or the keyboard device 14 (step S206V). If the enlargement is in the horizontal direction, value X (along horizontal axis) of the coordinates (X, Y) of the reference position of area C to be enlarged is changed in the positive (+) or negative (−) direction with respect to the position of the mouse pointer P moved by the pointing device 13 or the keyboard device 14 (step S206 H).

Then a process similar to steps S104 to S108 in FIG. 3 is performed on the updated area (C) to enlarge the image within area C and display it in window W3 (step S207V or 207H). Because window W3 is based on the position of mouse pointer P moved by the operation of the pointing device 13 or keyboard device 14, the window is moved with respect to the previous position.

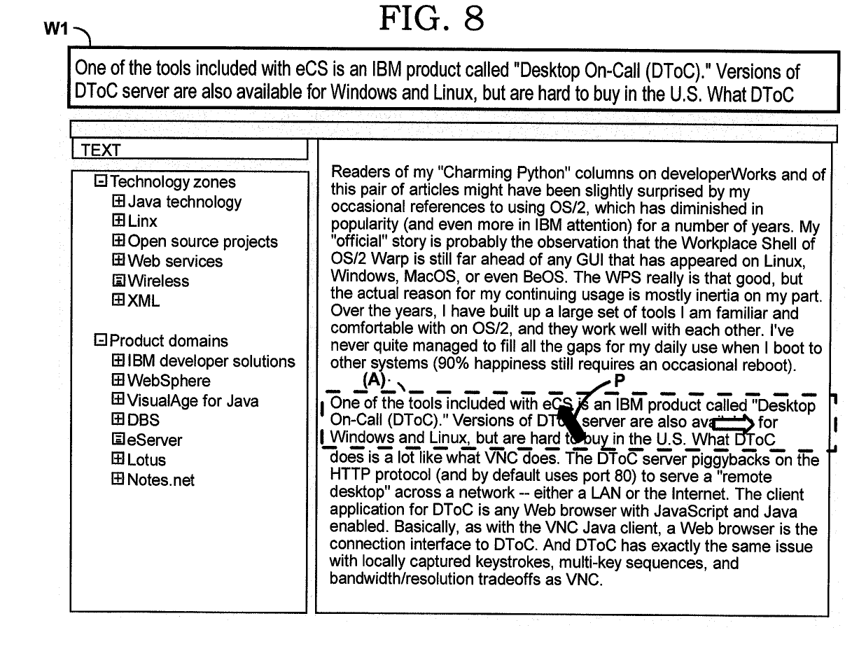

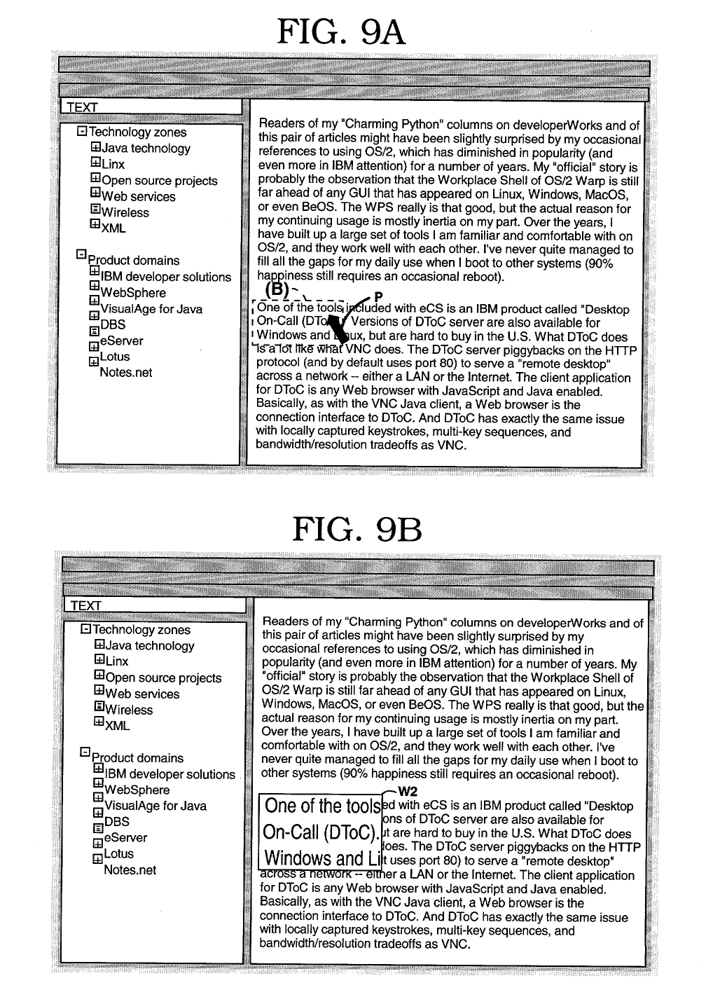

As described above, an image in a portion of the display screen is enlarged in only one direction and displayed in window W3, W′3. For example, when text (character strings) in a horizontal direction is displayed, the image (characters) of a portion of the display screen is enlarged in the vertical direction. When text in a vertical direction is displayed, the image (character) is enlarged in the horizontal direction. Thus, the entire line is displayed in window W3, W3′ as in the state before the enlargement. The user does not have to scroll text while reading a particular line, unlike the conventional manner shown in FIG. 8 or 9, improving convenience for the user as well as the visibility of the text.

Windows W3 and W3′ are displayed across the full width of (in the horizontal direction) or from top to bottom of (in the horizontal direction) the display area.

Therefore when scrolling in order to change the text line to be displayed in window W3, W3′, only a change in position of mouse pointer P in the vertical or horizontal direction needs to be detected. If mouse pointer P moves to the left or right in window W3 for horizontal writing, for example, the display in window W3 would not be affected by that movement. Therefore an area displayed in window W3 or W3′ does not shift in an unintended direction during scrolling, thereby improving the usability of the function and the readability of the text.

In addition, because window W3 or W3′ is displayed over an area (C) specified with mouse pointer P, the user does not need to move the eyes farther in order to read the enlarged text, improving the readability of the text for the user. In addition, if anti-aliasing is used during enlarging characters in window W3, W3′, the readability of the text is further improved.

Furthermore, the text is enlarged by image processing based on data concerning the image stored in the display memory 16. Thus, the enlargement as described above can be accomplished without exchanging data with an application program such as a word processor. Therefore, any image displayed in any application program can be enlarged.

Any image processing method may be used in enlarging an image in area C specified with mouse pointer P, or any method may be used for anti-aliasing characters in area C in the above-described embodiment.

While in this embodiment Window W3 or W3′ is displayed over an area (C) specified with mouse pointer P, it may be displayed at the upper, lower, left, or right edge of the display area of the display unit 12 or in a position at a predetermined distance from the edges with respect to mouse pointer P.

Furthermore, the program for enlarging a portion of the display screen in one direction as described above may be a program within an application program or a plug-in program of an application program. In such a case, the enlargement as described above is performed of course only on an application window 50 displayed on the display unit 12 by that application program.

If the program for performing the process as described above is incorporated in an application program, enlargement does not necessarily require image processing described above. That is, internal processing in the application program may provide an area in a portion of the application window 50, extract text data on the text displayed within the area, and change the font of characters displayed based on the extracted text data to enlarge the text. The font of the characters displayed is enlarged in one direction (in the vertical direction in horizontal writing, or in the horizontal direction in vertical writing) and the enlarged font is used for characters to be displayed. Window W3 may be provided across the full width (or from the top to bottom) of the application window 50 displayed by the application program, or may be provided across (or from the top to bottom) of an area in the application window 50 in which text is displayed. In such a case, when shifting area C to be displayed in window W3, a cursor (pointer) that moves from line to line on the text displayed in the application window 50 with the operation of an arrow key of the keyboard device 14 may be used as the base for providing area C, instead of mouse pointer P.

The computer system or the device enabling the above-described enlargement may be a mobile phone terminal, Personal Digital Assistants (PDA), car navigation system, besides a PC. Similar configuration may be applied also to a video game machine using a television set as its display device or a set-top box having display control capability.

The image, a portion of which is enlarged in one direction, can be not only displayed as a video image, but also output as a print. Again, the visibility of the image to the user is improved and other advantages as those of the above-described embodiment are provided.

The program for making a computer enlarge characters or an image within an area provided in a portion of the display area in the horizontal or vertical direction as described in the above-described embodiment may take the form of a storage medium or program transmission apparatus as described below.

That is, the program executed by the computer as described above may be stored in a storage medium such as a CD-ROM, a DVD, memory, or a hard disk in a computer-readable manner.

The program transmission apparatus may comprise storage means, such as a CD-ROM, a DVD, memory, or a hard disk, on which the above-described program is stored, and transmission means for reading the program from the storage means and transmitting it to a computer system which executes the program through a connector or a network such as the Internet or a LAN.

In the drawings and specifications there has been set forth a preferred embodiment of the invention and, although specific terms are used, the description thus given uses terminology in a generic and descriptive sense only and not for purposes of limitation.

We claim as our invention:

1. An apparatus comprising:
a display;
a display controller which controls said display; and
an event generator, coupled to said display controller, which accepts user operation data and generates an event;
said display controller responding to generation of the event by enlarging a predetermined area of said display along a first display direction, the display direction orthogonal to the first display direction remaining unenlarged.

2. Apparatus according to claim 1, wherein said display controller sets said predetermined area to be substantially the area across one full dimension of said display.

3. Apparatus according to claim 1, wherein said display controller further comprises:
an anti-aliasing circuit which applies anti-aliasing to the enlarged image.

4. Apparatus according to claim 1, wherein said display controller displays the enlarged image in an area substantially overlaying said predetermined area.

5. A display comprising:
an optical output device which produces humanly visible image output;
an input circuit which detects a predetermined input provided from an external source; and
an optical output device controller, coupled to said optical output device and to said input circuit, which enlarges a predetermined image area of said optical output device along a first dimension of said optical output device when said input circuit detects the predetermined input, the image area orthogonal to the first dimension remaining unenlarged.

6. The display to claim 5, wherein said optical output device controller further comprises:
a data retriever which retrieves data which is the source of the image displayed in the optical output device; and
an enlarger which enlarges the image based on the retrieved data.

7. An apparatus comprising:
an image display;
an image receiver which receives a first image provided by an external source; and
a display controller, coupled to said image display and to said image receiver, which generates a second image as a function of the first image and generates a third image for output on said image display which third image is enlarged relative to the first image along a first display direction, the display direction orthogonal to the first display direction remaining unenlarged.

8. Apparatus according to claim 7, wherein said third image is obtained by overlaying said second image on said first image.

9. The output device according to claim 7, wherein the direction of the enlargement is a direction orthogonal to a direction in which character strings displayed in said first image run.

10. A display controller comprising:
a pointer position identification module which identifies the position of a pointer displayed on a display unit;
an enlargement module which sets a predetermined area of the display unit for enlarged output to the display unit based on the position of the pointer identified by said pointer position identification module; and
an image obtaining module which obtains an image in the area set by said enlargement module;
wherein the enlargement module enlarges the image obtained by said image obtaining module along a first display direction and the display direction orthogonal to the first display direction remaining unenlarged.

11. The display controller according to claim 10, further comprising
an anti-aliasing module which applies anti-aliasing to a character contained in the image obtained by said image obtaining module.

12. The display controller according to claim 10, wherein said enlargement module retrieves data relating to the image in said area and performs enlargement as a function of said data relating to the image.

13. The display controller according to claim 10, further comprising:
an image storage which stores data related to the image obtained by said image obtaining module; and
an image restore module which displays the image stored in said image storage on the display unit by replacing the image enlarged by said enlargement module.

14. A computer program for execution on a computer system for controlling a display unit comprising the steps of:
detecting a command input from an external source for requesting enlargement;
setting an area in a portion of the display area of said display unit when detecting said request command;
enlarging a character in said area in only one direction relative to said character where the direction is a horizontal direction or a vertical direction; and
outputting image data with the enlarged character.

15. The computer program according to claim 14, wherein said character is enlarged in one direction by changing the font of said character in said area in said enlarging step.

16. The computer program according to claim 14, wherein said area is set within an application window generated according to an application program in said setting step.

17. A computer program product comprising:
a computer usable medium having computer readable program code embodied therein which improves the visibility of a display, the computer readable program code in said computer program product effective in executing the steps of:
detecting a command input from an external source requesting enlargement;
retrieving image area data representing a portion of the display when said request command is detected;
enlarging said retrieved image area data in only one predetermined direction, the direction orthogonal to the one predetermined direction remaining unenlarged; and
outputting enlarged image data.

18. A method for processing an image displayed on a display unit, comprising the steps of:
setting an area in a portion of an image displayed on the display unit in response to a user request;
retrieving data pertaining to an image in said area;
enlarging the image in said area in one predetermined direction based on said data pertaining to said image, the direction orthogonal to the one predetermined direction remaining unenlarged; and
displaying the enlarged image on the display unit.

19. The image processing method according to claim 18, wherein the direction of the enlargement of said image in said area is a direction orthogonal to a direction in which character strings displayed in said image run.
